(19) United States
(12) Patent Application Publication
(10) Pub. No.: US 2017/0191268 A1
(43) Pub. Date: Jul. 6, 2017

(54) Pre-Stressed Concrete Body

(71) Applicant: Faddis Concrete Products d/b/a Hessian Co., LTD., Honey Brook, PA (US)

(72) Inventors: Jonathan M. LaFauci, Reading, PA (US); Andrew Weaver, Baltimore, MD (US); Kevin L. Iddings, Lititz, PA (US)

(73) Assignee: Faddis Concrete Products d/b/a Hessian Co., LTD., Honey Brook, PA (US)

(21) Appl. No.: 14/989,398

(22) Filed: Jan. 6, 2016

(51) Int. Cl. E04C 3/34; B28B 23/06; B28B 23/04; E04C 5/08; B28B 1/14

(52) U.S. Cl. CPC E04C 3/34; E04C 5/085; B28B 1/14; B28B 23/043; B28B 23/06

(57) ABSTRACT

A pre-stressed concrete body is disclosed. The concrete body is elongated with a first end and an opposite second end. A plurality of reinforcement strands within the concrete body extend from the first end to the second end and impart a compressive force. A baseplate is disposed on the first end, and has a plurality of first fastener receiving holes and a plurality of second fastener receiving holes.

### FIELD OF THE INVENTION

The invention relates to a structural concrete body, and more particularly to a pre-stressed concrete body.

### BACKGROUND

Concrete cast bodies, and particularly posts, are known and commonly used to provide support in construction and building applications. The concrete that forms the post is strong in resisting compressive forces, but is weak in tension. In order to use concrete posts in tensile applications, manufacturers reinforce the concrete post with additional material, commonly steel rebar, which bears the tensile load. Rebar can take many different forms and is placed in a myriad of orientations within the post depending on the application. The cost to manufacture such a reinforced concrete post dramatically increases in proportion to the quantity of rebar used.

Emeca SPEusa (http://www.emeca-speusa.com/pre_casting_jointed_piles.shtml) thus discloses a concrete post and method of manufacturing a concrete post containing pre-stressed reinforcing material. Pre-stressing, or placing the reinforcing material under a tensile load while the concrete is curing, results in a compressive load applied to the concrete body once the concrete has cured and the reinforcing material is separated from the tensile force. For a given quantity of reinforcing material, the additional compressive load resulting from pre-stressing offers added tensile strength in comparison to typical non-stressed applications. Pre-stressing thus lowers material cost for creating a similarly strong or stronger concrete post.

Emeca SPEusa further discloses a face plate cast to the concrete post as it cures during the manufacturing process (http://www.emeca-speusa.com/jointed_pile_installation.shtml). The face plate permits connection to another concrete post already installed in a foundation, and includes a separate mirrored, interlocking face plate at the installation surface. The face plates are fastened via locking pins driven into the concrete and face plates (http://www.emeca-speusa.com/jointed_pile_installation.shtml; https://en.wikipedia.org/wiki/Pile_splice).

The locking pins of known pre-stressed concrete posts are not removable; an attached concrete post cannot be un-attached and re-attached in a different location. This severely limits the versatility and usefulness of pre-stressed concrete posts.

### SUMMARY

An object of the invention, among others, is to provide a removable pre-stressed concrete body. The concrete body is elongated with a first end and an opposite second end. A plurality of reinforcement strands within the concrete body extend from the first end to the second end and impart a compressive force. A baseplate is disposed on the first end, and has a plurality of first fastener receiving holes and a plurality of second fastener receiving holes.

### BRIEF DESCRIPTION OF THE DRAWINGS

The invention will now be described by way of example with reference to the accompanying figures, of which:

FIG. 1 is a front cross-sectional view of a pre-stressed concrete body according to an embodiment of the current invention;

FIG. 2 is a plan view of the baseplate of the pre-stressed concrete body;

FIG. 3 is a perspective view of the bottom of the baseplate of the pre-stressed concrete body;

FIG. 4 is a front cross-sectional view of a pre-stressed concrete body according to a second embodiment of the current invention;

FIG. 5 is an exploded perspective view of a pre-stressed concrete body in a mold according to a third embodiment of the current invention;

FIG. 6 is a front view of the pre-stressed concrete body attached to a surface;

FIG. 7 is a perspective view of a pre-stressed concrete body attached to a surface according to a fourth embodiment of the current invention.

### DETAILED DESCRIPTION OF THE EMBODIMENT(S)

The invention is described in detail below with reference to embodiments of a pre-stressed concrete body and a method of manufacture of a pre-stressed concrete body. The invention may, however, be embodied in many different forms and should not be construed as limited to the embodiments set forth herein; rather, these embodiments are provided so that this disclosure will be thorough and complete and still fully convey the scope of the invention to those skilled in the art. Each of the described examples are illustrated in the accompanying drawings, wherein like reference numerals refer to the like elements throughout. The embodiments are described below in order to explain the invention by referring to the figures.

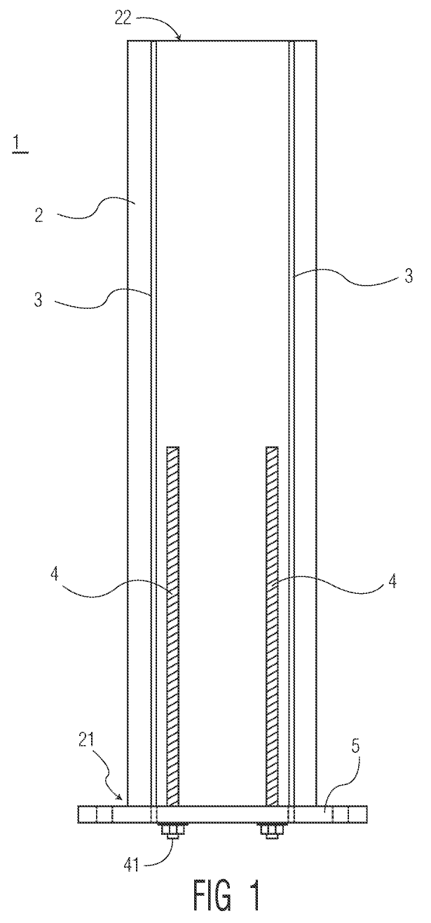

FIG. 1 shows a pre-stressed concrete body 10 according to an embodiment of the invention, in a cross-sectional front view. The body 10 includes a concrete portion 20, reinforcement strands 30, first fasteners 40, and a baseplate 50. Each of these major components will now be described in greater detail.

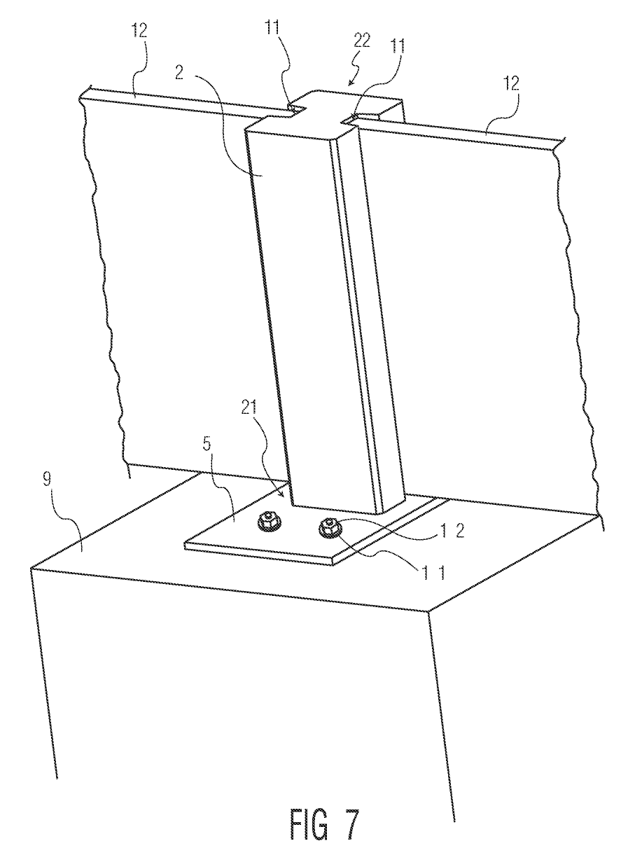

The concrete portion 20 forms an elongated shape with a first end 21 and a second end 22, as shown in FIG. 1. In the embodiment shown in FIG. 1, the concrete portion 20 is an elongated rectangular shape, but one skilled in the art would appreciate that the concrete portion 20 could be an elongated H-shape as shown in FIG. 7, a cylindrical shape, or a variety of other shapes.

The reinforcement strands 30 run from the first end 21 to the second end 22. The strands 30 may, for example, be high tensile steel, or any other similar material known to those with ordinary skill in the art.

FIG. 1 also shows the orientation of the plurality of first fasteners 40 with respect to the body 10. The first fasteners 40 are positioned in the first end 21, and extend within the concrete portion 20 part of the distance between the first end 21 and the second end 22. In an exemplary embodiment, the first fasteners 40 extend greater than one-sixth and less than one-half of the distance between the first end 21 and the second end 22. A portion 41 of the first fasteners 40 also extends outward from the first end. The first fasteners 40 are threaded. The first fasteners 40 may, for example, be steel anchor bars, or any other similar material known to those with ordinary skill in the art.

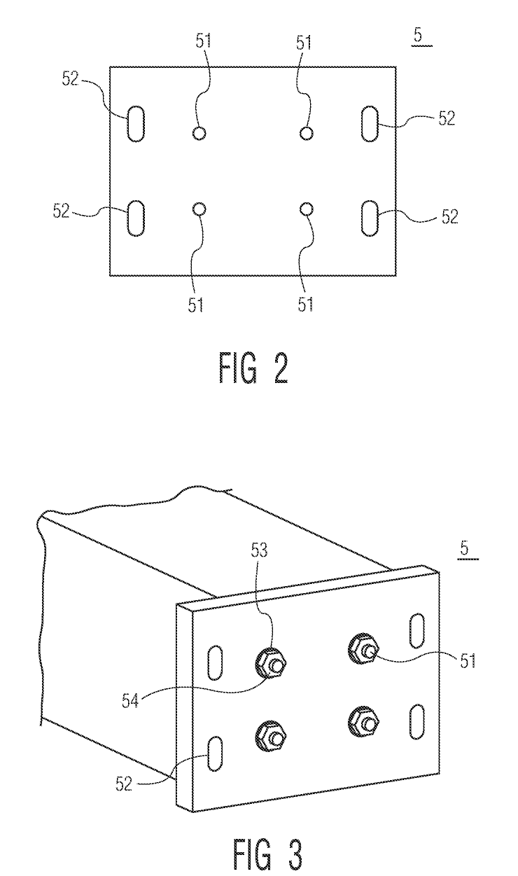

The baseplate 50, as depicted in the plan view of FIG. 2, includes a plurality of first fastener receiving holes 51 and a plurality of second fastener receiving holes 52. Referring to the front view of FIG. 1, the first fastener receiving holes 51 are covered on the top side of the baseplate 50 by the concrete portion 20, while the second fastener receiving holes 52 are on a portion of the baseplate 50 exterior of the concrete portion 20. The orientation of the first and second fastener receiving holes 51 and 52 on the baseplate 50, and with respect to the concrete portion 20, is also clearly seen in the perspective view of FIG. 3. FIG. 3 also shows washers 53 and nuts 54 positioned on the ends of threaded first fasteners 40 and abutting the baseplate 50.

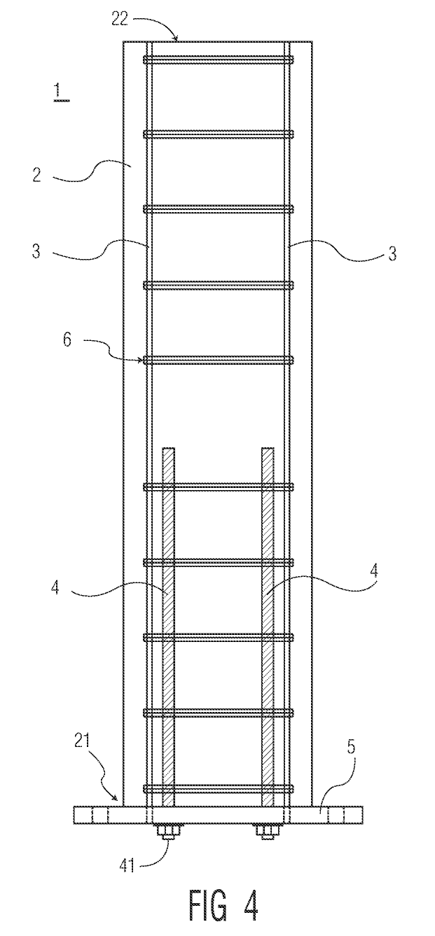

In an alternative embodiment shown in FIG. 4, a plurality of reinforcement stirrups 60 are additionally spaced between a first end 21 and a second end 22 of the concrete portion 20. The stirrups 60 may, for example, be a steel material, or any other similar material known to those with ordinary skill in the art.

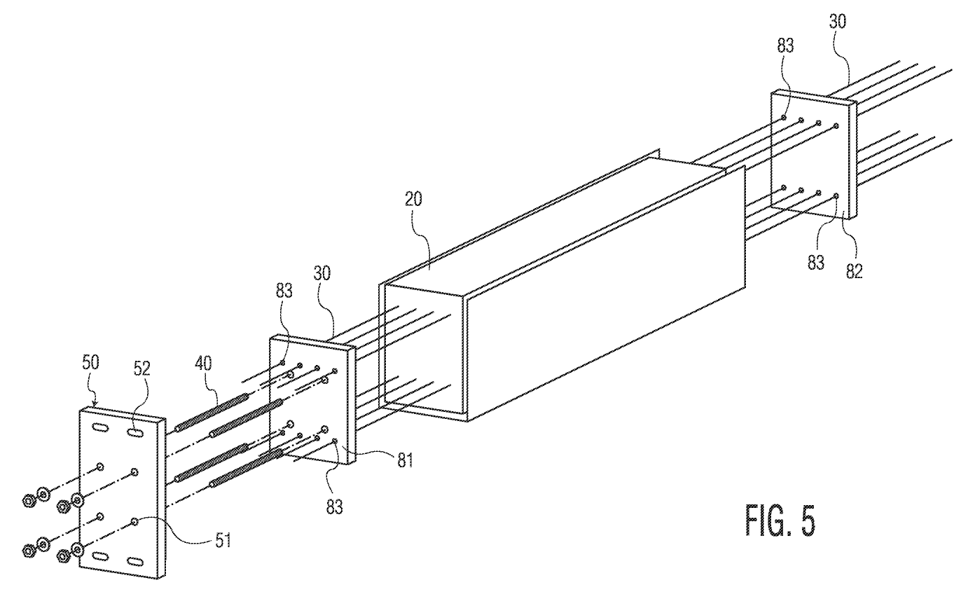

A method of manufacturing the pre-stressed concrete body 10 will now be described primarily with reference to FIG. 5, which is an exploded perspective view of the concrete portion 20 in a manufacturing mold.

The manufacturing process begins with the formation of a mold structure including temporary plates 81 and 82 at each end to create an elongated form with an open top. Both first temporary plate 81 and second temporary plate 82 have a first plurality of holes 83, while first temporary plate 81 additionally has a second plurality of holes 84.

Next, reinforcement strands 30 are strung through the first plurality of holes 83 on temporary plate 81, within and along the length of the mold, and through the first plurality of holes 83 on temporary plate 82, extending outside of the mold on both ends.

Hydraulic jacks (not shown) supported and restrained by the mold are then used to apply tension to the reinforcement strands 30. In an exemplary embodiment, the jacks stretch the strands 30 to between seventy and eighty percent of their ultimate strength. With the strands 30 under tension, concrete is poured into the mold. Before the concrete cures, first fasteners 40 are inserted through the second plurality of holes 84 on temporary plate 81 and into the concrete contained within the mold. As shown and described above with reference to FIG. 1, the first fasteners 40 extend within the concrete portion 20 part of the distance between the first end 21 and the second end 22, while a portion 41 of the first fasteners 40 remains extending outward from the first end 21. At this point in the process, the reinforcement stirrups 60 shown in the alternative embodiment of FIG. 4 may also be embedded into the concrete.

The mold may be used to form one concrete portion 20 containing the reinforcement strands 30, as shown in FIG. 5. The mold alternatively may be a longer structure sectioned with the temporary plates 81, 82 such that a plurality of concrete portions 20 may be poured end-to-end. In this embodiment, the reinforcement strands 30 extend through the plurality of concrete portions 20 without gaps between the temporary plates 81, 82 and concrete portions 20. As in the single mold embodiment, the reinforcement strands 30 are stretched outside of the outermost ends of the mold.

The strands 30 are severed at the temporary plates 81 and 82 when the concrete hardens. When removing the hardened concrete 20 from the mold, the temporary plates 81 and 82 are also removed, leaving a concrete portion 20 containing reinforcement strands 30 with a portion of first fasteners 40 extending out of the first end 21.

Lastly, the baseplate 50 is permanently installed on the first end 21 of the pre-stressed concrete portion 20. The first fastener receiving holes 51 of the baseplate 50 fit over the portion of the first fasteners 40 extending out of the first end 21, and the baseplate 50 is fastened to the first end 21 using the washers 53 and nuts 54 as depicted in FIG. 3.

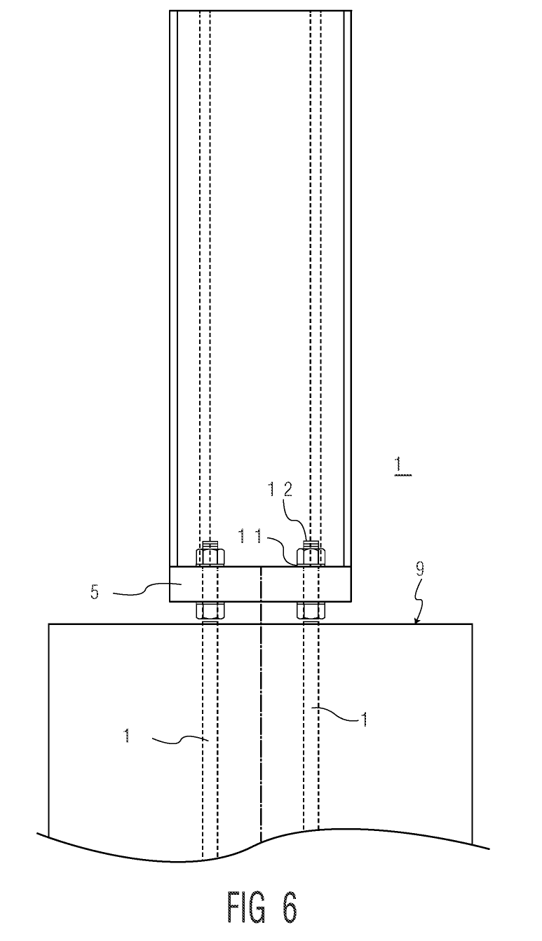

The completed pre-stressed concrete body 10 can be used in a wide variety of applications, including, but not limited to, support for highway noise barriers, support for an earth retaining wall, as elements of building construction, and as a free-standing pole support. The body 10 is installed on a surface, for example, an existing foundation. As shown in FIG. 6, a plurality of threaded second fasteners 100 extend upward from the installation surface 90. The body 10 is positioned such that the threaded second fasteners 100 align with the second fastener receiving holes 52, and the bottom of the baseplate 50 abuts the surface 90. Washers 101 and nuts 102 are placed on the threaded second fasteners 100, and abut the top of the baseplate 50. Removing the washers 101 and nuts 102 from the threaded second fasteners 100 allows the pre-stressed concrete body 10 to be removed from a particular application and re-positioned in a different location.

In another embodiment of the pre-stressed concrete body 10, the circumference of the concrete portion 20 includes indentations 110, as depicted in FIG. 7. The indentations 110 are positioned on the two opposite sides of the concrete portion 20 parallel to the longitudinal axis of the baseplate 50, and extend from the first end 21 to the second end 22 of the concrete portion 20. The indentations 110 can laterally receive and support panels 120 to allow the pre-stressed concrete posts to be used in a wider range of applications.

The embodiments of the invention described above offer a number of advantages in comparison with the prior art. The pre-stressed concrete body 10, by virtue of including the pre-tensioned reinforcement strands 30, can bear a same or greater load at a lower cost than a conventional non-stressed concrete body. The decreased quantity of reinforcing material required also lessens the weight of the concrete body, improving maneuverability. Furthermore, the baseplate 50 does not require damaging the concrete in order to fasten the body to a surface or foundation, and can be undone without affecting the future load-bearing performance of the body. This removability can save costs and ease the use of pre-stressed concrete bodies in myriad ways, including recycling previously used concrete bodies and lessening the time required to remove and replace a damaged body. Additionally, the embodiment of the mold permitting the simultaneous pouring of multiple concrete bodies conserves time while limiting reinforcement strand waste.

Although embodiments of the present invention have been shown and described, the present invention is not limited to the described embodiments. Suitable results may be achieved if the described techniques are performed in a different order, and/or if components in a described system, architecture, device, or circuit are combined in a different manner, and/or replaced or supplemented by other components or their equivalents. It would be appreciated by those skilled in the art that changes may be made to these embodiments without departing from the principles and spirit of the invention, the scope of which is defined by the claims and their equivalents.

1. A pre-stressed concrete body, comprising:
an elongated concrete body having a first end and an opposite second end;
a plurality of reinforcement strands within the concrete body and extending from the first end to the second end, the reinforcement strands imparting a compressive force; and
a baseplate disposed on the first end, wherein the baseplate further comprises a plurality of first fastener receiving holes and a plurality of second fastener receiving holes.

2. The pre-stressed concrete body of claim 1, further comprising a plurality of first fasteners embedded in the first end and extending outward from the first end through the plurality of first fastener receiving holes.

3. The pre-stressed concrete body of claim 2, wherein the first fasteners are threaded on an end extending outward from the first end.

4. The pre-stressed concrete body of claim 2, wherein a portion of each of the first fasteners within the concrete body extends less than a full distance between the first end and the second end.

5. The pre-stressed concrete body of claim 3, wherein a portion of each of the first fasteners within the concrete body extends less than a full distance between the first end and the second end.

6. The pre-stressed concrete body of claim 1, wherein the plurality of second fastener receiving holes receive a plurality of second fasteners extending from below the baseplate to above the baseplate.

7. The pre-stressed concrete body of claim 6, wherein the baseplate of the body is removably fastened to a surface below the baseplate using the second fasteners.

8. The pre-stressed concrete body of claim 2, wherein the plurality of second fastener receiving holes receive a plurality of second fasteners extending from below the baseplate to above the baseplate.

9. The pre-stressed concrete body of claim 8, wherein the baseplate of the body is removably fastened to a surface below the baseplate using the second fasteners.

10. The pre-stressed concrete body of claim 9, further comprising a plurality of reinforcement stirrups spaced between the first end and second end and orthogonal to a direction of the reinforcement strands.

11. A method of manufacturing a pre-stressed concrete body, comprising:
forming an elongated mold structure with sides, a bottom, a first end, and an opposite second end;
stringing reinforcement strands within the elongated mold, along the length of the mold;
stretching the reinforcement strands;
pouring concrete into the mold;
severing the reinforcement strands at each of the first and second ends when the concrete has hardened;
removing the concrete body from the mold;
installing a permanent baseplate on the first end.

12. The method of claim 11, wherein the forming step further comprises installing temporary plates at the first and second ends that fit within the mold structure.

13. The method of claim 12, wherein the stringing step further comprises stringing the reinforcement strands through a first plurality of holes in the temporary plates at the first and second ends.

14. The method of claim 13, wherein the severing step further comprises severing the reinforcement strands at each of the temporary plates.

15. The method of claim 14, wherein the removing step further comprises removing the temporary plates.

16. The method of claim 11, wherein the stretching step is accomplished by using hydraulic jacks constrained by the mold structure.

17. The method of claim 13, further comprising embedding a plurality of threaded first fasteners into the mold on the first end through a second plurality of holes in the temporary plate on the first end, and leaving a portion of each of the plurality of threaded first fasteners extending outward from the first end.

18. The method of claim 17, wherein the removing step further comprises removing the temporary plates.

19. The method of claim 18, wherein the installing step further comprises fitting a plurality of first fastener receiving holes of the baseplate over the first fasteners extending outward from the first end, and fastening the baseplate to the first end using the threaded first fasteners.

20. The method of claim 11, further comprising embedding a plurality of reinforcement stirrups into the mold spaced between the first end and second end and orthogonal to the direction of the reinforcement strands.

21. The pre-stressed concrete body of claim 2, wherein the plurality of first fasteners are spaced apart from the plurality of reinforcement strands.

22. The pre-stressed concrete body of claim 2, wherein the plurality of first fasteners are steel anchor bars.

23. The pre-stressed concrete body of claim 4, wherein the portion of each of the first fasteners within the concrete body extends greater than one-sixth and less than one-half of the full distance between the first end and the second end.

24. The pre-stressed concrete body of claim 1, wherein the plurality of reinforcement strands are wholly contained within the concrete body.
